(19) United States
(12) Patent Application Publication
(10) Pub. No.: US 2025/0268768 A1
(43) Pub. Date: Aug. 28, 2025

(54) ACTIVE PRESSURE RELIEVING SYSTEM

(71) Applicants: University of Pittsburgh - Of the Commonwealth System of Higher Education, Pittsburgh, PA (US); The United States Government as represented by the Department of Veterans Affairs, Washington, DC (US)

(72) Inventors: Rory Alan Cooper, Gibsonia, PA (US); Brad E. Dicianno, Oakmont, PA (US); Garrett G. Grindle, Pittsburgh, PA (US); James D. Fisher, Pittsburgh, PA (US); Rosemarie Cooper, Gibsonia, PA (US); Guy M. Stofman, Oakmont, PA (US)

(21) Appl. No.: 18/702,962

(22) PCT Filed: Oct. 21, 2022
(86) PCT No.: PCT/US2022/047408

§ 371 Date: Apr. 19, 2024

Related U.S. Application Data
(60) Provisional application No. 63/270,248, filed on Oct. 21, 2021.

(51) Int. Cl. A61G 5/10; A61G 7/057

(52) U.S. Cl. CPC A61G 5/1045; A61G 5/1048; A61G 7/05746

(57) ABSTRACT

A pressure relief system for use with a wheelchair includes a backrest support including a plurality of backrest cells. The backrest cells include a base which includes a plurality of air ports, a cover in connection with the base, and resilient elements within an interior of the backrest cells. The pressure relief system-further includes a seat support including a plurality of seat cells. The seat cells includes a base which includes a plurality of air ports, a cover in connection with the base, and resilient elements within an interior of the seat cells. The pressure relief system also includes a source of pressurize air in fluid connection with the air ports of each of the backrest cells and with the air ports of the seat cells via which the resilient elements within the backrest cells and the resilient elements within the seat cells are fluidizable.

### CROSS-REFERENCE TO RELATED APPLICATIONS

This application claims benefit of U.S. Provisional Patent Application Ser. No. 63/270,248, filed Oct. 21, 2021, the disclosure of which is incorporated herein by reference.

### GOVERNMENTAL INTEREST

This invention was made with government support under grant number B2988C awarded by the United States Department of Veterans Affairs. The government has certain rights in the invention.

### BACKGROUND

The following information is provided to assist the reader in understanding technologies disclosed below and the environment in which such technologies may typically be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

There are approximately 3.6 million wheelchair users in the US. Over half of wheelchair users develop pressure injuries (PI). Among people with spinal cord injuries (sometimes referred to herein as SCI), in particular, it has been estimated that 25% will develop pressure injuries each year. There are approximately 250,000 individual with spinal cord injuries in the US, of whom greater than 30,000 are veterans. Pressure injuries harm overall health, productivity, independence, social interaction, and quality of life. The average direct cost of treating a pressure injury is approximately $20,000 without surgery and approximately $200,000 when surgery is required, resulting in billions of dollar being spent each year. Moreover, the indirect cost in loss of productivity and diminished quality of life is higher. Many flap surgeries are performed on individuals with spinal cord injuries each year to help them recover from pressure injuries. A flap surgery is a technique in the field of plastic and reconstructive surgery in which tissue which includes an intact blood supply is lifted from a donor site and moved to a recipient site. Flap surgery may, for example, be performed to address a wound resulting from injury or surgery in cases in which the tissue surrounding the wound cannot support a graft which lacks an intact blood supply. Studies show that greater than 25% of spinal cord injury patients undergoing flap surgery have a recurring injury after returning home. Existing technology is insufficient for those people, especially in the interim period, upon returning home following surgery and hospitalization, during which the skin has not fully recovered.

Over 2.5 million pressure injuries are treated each year in the U.S. at a cost of over $11 billion. The incidence of pressure injuries in people with SCI (PwSCI) ranges from 20-30%, and prevalence ranges from 10-30%. As set forth above, skin flap surgery may be needed to close a non-healing pressure injury. Complication rates vary from flap surgeries but can be as high as 80%. Hospital acquired, stage IV pressure injuries and related complications cost approximately $129K, and community-acquired stage IV pressure injuries cost over $124K per wound. Managing pressure injuries in PwSCI alone costs $1.2 to $1.3 billion per year in the U.S., and prevention is estimated to cost less than a tenth of that figure. Mortality from pressure injuries can be as high as 60% in those with risk factors such as reduced mobility.

Pressure injuries most commonly develop over the sacrum and ischial tuberosities as a result of impaired sensation, weakness, and muscle atrophy. Decreased movement and lack of perception of pressure can lead to decreased tissue oxygenation, which can be compounded by shear, moisture, heat, and inadequate nutrition. Since most pressure injuries occur from prolonged sitting, having a wheelchair with an optimal pressure reduction surface is critical. Clinical practice guidelines for prevention and treatment of pressure injuries for PwSCI include providing appropriate pressure support technologies. Pressure relieving technologies are currently limited to wheelchair cushions and backrests, wheelchair seating functions, and pressure-reducing support surfaces. Pressure relieving wheelchair cushions attempt to redistribute forces away from the bony prominences of the sacrum and ischial tuberosities.

Wheelchair cushions may, for example, be formed from foam, gel, air cells, and other materials, including hybrid gel/foam technology. Some cushions and backrests are specifically designed for skin protection or positioning plus skin protection. Wheelchair cushions can also be custom-designed. ROHO® air cushions and backrests, available from Roho of Illinois of Bellville, Illinois, US, are used extensively for pressure injury in high-risk individuals. Alternating pressure cushions are battery-powered, prefabricated cushions in which an air pump provides either sequential inflation or deflation of the air cells or a low interface pressure throughout the cushion.

Wheelchair seating functions on electric powered wheelchairs (EPW) and manual wheelchairs allow the user or caregiver to change the seat positioning to offload pressure. On an EPW, this is achieved through use of the control interface such as the joystick or through accessory switches/buttons. Clinical guidelines regarding the proper use of such features are described in detail in the Rehabilitation Engineering and Assistive Technology Society of North America (RESNA) position paper on The Application of Tilt, Recline, and Elevating Legrests for Wheelchairs., available from RESNA and published at www.resna.org/Portals/0/Documents/Position %20Papers/RESNA%20PP%20on%20Tilt%20 Recline_2017.pdf. Tilt systems allow users to change their seat angle orientation in relation to the ground while maintaining a constant seat to back angle and seat to leg support angle. Recline functionality allows users to change seat to back angle and maintain constant seat angle with respect to the ground. Studies reviewed in the RESNA position paper show that tilt and recline affect pressure and perfusion at the skin and muscle tissue at the ischial tuberosities, and to a minimum extent, at the sacrum. Tilt, when used alone, must be greater than about 25° to achieve pressure relief and/or tissue perfusion at the ischial tuberosities. Recline, when used alone, can increase shear but may provide reduction in pressure at the ischial tuberosities at angles greater than 90-100°. The greatest reductions in pressure are seen when tilt and recline are used together, either at tilt of 35° with recline 100° or tilt of 15-25° with recline of 120°. Users can achieve better pressure relief with longer durations of tilt and recline. However, when the seat is reclined and/or tilted to the extent recommended for pressure relief, the user is limited in their ability to drive the chair or perform most functional activities. Attendant-propelled manual wheelchairs may include a manual tilt feature, but these wheelchairs are primarily operated by a caregiver and are not meant for independent self-propulsion.

Medicare categorizes pressure-reducing support into three groups. Group 1 support surfaces replace a standard hospital or home mattress or act as an overlay on top of a mattress. Products in this category include mattresses, pressure pads, and mattress overlays (which may be foam, air, water, or gel). Group 2 support surfaces replace a mattress and include powered air flotation beds, powered pressure reducing air mattresses, and non-powered advanced pressure reducing mattresses. Group 3 support surfaces are complete bed systems, known as air-fluidized beds, which use the circulation of filtered air through silicone beads and are considered the gold standard. A number of air fluidized therapy beds are available under the CLINITRON® brand are available from Hill-Rom Holdings, Inc of Chicago, Illinois. Such beds are filled with silicone coated microspheres which resemble white sand. Temperature-controlled air is forced upward through these microspheres to create a dynamic fluid-like state. This fluid support optimizes immersion and envelopment, conforming to the irregularities of the body. The fluid-like environment also reduces the mechanical stress of friction and shear which are forces that can cause skin breakdown. Variable temperature air flow regulates heat and moisture to help control the skin's microclimate and facilitate healing. Air pushed through such silicone beads creates a fluid-like environment which reduces shear and pressure. A Cochrane review revealed that air-fluidized beds and low air-loss beds are better than standard beds in promoting pressure healing and recommended them as therapeutic interventions. Cullum NA, et al., Beds, mattresses and cushions for pressure sore prevention and treatment. Cochrane Database of Systematic Reviews, Issue 2. Art. No.: CD001735. DOI: 10.1002/14651858.CD001735 (2000). Air fluidized therapy has also been found to produce less shear, lower peak sacral interface pressure, and better evaporative capacity, compared to Group 2 surfaces. However, Group 3 support surfaces are available only as beds.

### SUMMARY

In one aspect, a pressure relief system for use with a wheelchair includes a backrest support including a plurality of backrest cells. Each of the plurality of backrest cells includes a base which includes a plurality of air ports, a cover in connection with the base, and resilient elements within an interior of each of the plurality of backrest cells. The pressure relief system further includes a seat support including a plurality of seat cells. Each of the plurality of seat cells includes a base which includes a plurality of air ports, a cover in connection with the base, and resilient elements within an interior of each of the plurality of seat cells. The pressure relief system also includes a source of pressurized air in fluid connection with the plurality of air ports of each of the plurality of backrest cells and with the plurality of air ports of each of the plurality of seat cells via which the resilient elements within each of the plurality of backrest cells and the resilient elements within each of the plurality of seat cells are fluidizable.

At least a portion of each cover of the plurality of backrest cells may, for example, be permeable to air and at least a portion of each cover of the plurality of seat cells is permeable to air. Each of the plurality of backrest cells may, for example, include between 30% and 90% by volume of the resilient elements, and each of the plurality of seat cells may, for example, include between 30% and 90% by volume of the resilient elements. The resilient elements may, for example, have an average diameter greater than 1 mm or greater than 2 mm. In a number of embodiments, the resilient elements within each of the plurality of backrest cells are generally spherical and the resilient elements within each of the plurality of seat cells are generally spherical.

In a number of embodiments, the base of each of the plurality of backrest cells includes one or more channels or conduits in fluid connection with the plurality of air ports thereof and an air inlet in fluid connection with the one or more channels thereof which is configured to be placed in fluid connection with the source of pressurized air. The base of each of the plurality of seat cells may likewise include one or more channels or conduits in fluid connection with the plurality of air ports thereof and an air inlet in fluid connection with the one or more channels thereof which is configured to be placed in fluid connection with the source of pressurized air.

In a number of embodiments, the pressure relief system further includes a control system configured to control air flow from the source of pressurized air to each of the plurality of backrest cells and to each of the plurality of seat sells. The control system may be configured to independently control air flow from the source of pressurized air to each of the plurality of backrest cells and to each of the plurality of seat cells. The control system may, for example, be configured to independently control air flow from the source of pressurized air to each of the plurality of backrest cells and to independently control air flow from the source of pressurized air to each of the plurality of seat sells. In a number of embodiments, the control system is configured to control air flow to the plurality of air ports of each of the plurality of backrest cells as a function of orientation of the plurality of backrest cells with respect to the gravity vector and control air flow to the plurality of air ports of each of the plurality of seat cells as a function of orientation of the plurality of seat cells with respect to the gravity vector. Groups of air ports and/or individual air ports may be controlled independently to achieve and/or optimize fluidization of the resilient elements over a range of angles backrest cells and/or seat cells with respect to the gravity vector.

In another aspect, a method of providing pressure support in a wheelchair includes providing a backrest support including a plurality of backrest cells, each of the plurality of backrest cells including a base which includes a plurality of air ports, a cover in connection with the base, and resilient elements within an interior of each the plurality of backrest cells, a seat support including a plurality of seat cells, each of the plurality of seat cell including a base which includes a plurality of air ports, a cover in connection with the base, and resilient elements within an interior of each of the plurality of seat cells, and a source of pressurized air in fluid connection with the plurality of ports of each of the plurality of backrest cells and in fluid connection with each of the plurality of air ports of each of the plurality of seat cells. The method further includes passing pressurized air through the plurality of air ports of the base of each plurality of backrest cells and through the plurality of air ports of the base of each the plurality of seat support cells via the source of pressurized air to fluidize the resilient elements within each of the plurality of backrest cells and within each of the plurality of seat cells.

As described above, at least a portion of each cover of the plurality of backrest cells may, for example, be permeable to air and at least a portion of each cover of the plurality of seat cells is permeable to air. Each of the plurality of backrest cells may, for example, include between 30% and 90% by volume of the resilient elements, and each of the plurality of seat cells may, for example, include between 30% and 90% by volume of the resilient elements. The resilient elements may, for example, have an average diameter greater than 1 mm or greater than 2 mm. In a number of embodiments, the resilient elements within each of the plurality of backrest cells are generally spherical and the resilient elements within each of the plurality of seat cells are generally spherical.

In a number of embodiments, the base of each of the plurality of backrest cells includes one or more channels in fluid connection with the plurality of air ports thereof and an air inlet in fluid connection with the one or more channels thereof which is configured to be placed in fluid connection with the source of pressurized air. The base of each of the plurality of seat cells may likewise include one or more channels in fluid connection with the plurality of air ports thereof and an air inlet in fluid connection with the one or more channels thereof which is configured to be placed in fluid connection with the source of pressurized air.

The method may further include providing a control system in operative connection with the seat support and with the backrest support which is configured to control air flow from the source of pressurized air to each of the plurality of backrest cells and to each of the plurality of seat sells. The control system may be configured to independently control air flow from the source of pressurized air to each of the plurality of backrest cells and to each of the plurality of seat sells. As described above, the control system may, in a number of embodiments, be configured to independently control air flow from the source of pressurized air to each of the plurality of backrest cells and to independently control air flow from the source of pressurized air to each of the plurality of seat sells. In a number of embodiments, the control system is configured to control air flow to the plurality of air ports of each of the plurality of backrest cells as a function of orientation of the plurality of backrest cells with respect to the gravity vector and control air flow to the plurality of air ports of each of the plurality of seat cells as a function of orientation of the plurality of seat cells with respect to the gravity vector. Groups of air ports and/or individual air ports may be controlled independently to effect and/or optimize fluidization of the resilient elements over a range of angles backrest cells and/or seat cells with respect to the gravity vector.

In a number of embodiments, the method further includes selecting the number, size and configuration of each of the plurality of backrest cells and each of the plurality of seat cells on the basis of at least one predetermined criterion. For example, the backrest cells and/or the seat cells may be designed for a particular patient, a particular injury or conditions, etc.

In a further aspect, a pressure relief system for use with a seating system in which a user can sit upright includes a seat support including a plurality of seat cells, wherein each seat cell includes a base which includes a plurality of air ports, a cover in connection with the base, and a plurality of resilient elements within an interior of each seat cell, and a source of pressurized air in fluid connection with the plurality of air ports of the plurality of seat cells via which the resilient elements within each of the plurality of seat cells are fluidizable. The pressure relief system may further include a backrest support including a plurality of backrest cells, wherein each backrest cell includes a base which includes a plurality of air ports, a cover in connection with the base, and a plurality of resilient elements within an interior of each of the plurality of backrest cells. In such embodiments, the source of pressurized air is also in fluid connection with the plurality of ports of each of the plurality of backrest cells via which the resilient elements within each of the plurality of backrest cells are fluidizable.

At least a portion of each cover of the plurality of backrest cells may be permeable to air and at least a portion of each cover of the plurality of seat cells may be permeable to air. In a number of embodiments, each of the plurality of backrest cells includes between 30% and 90% by volume of the resilient elements, and each of the plurality of seat cells includes between 30% and 90% by volume of the resilient elements. The resilient elements may, for example, have an average diameter greater than 1 mm or greater than 2 mm. In a number of embodiments, the resilient elements within each of the plurality of backrest cells are generally spherical, and the resilient elements within each of the plurality of seat cells are generally spherical.

The base of each of the plurality of backrest cells may include one or more channels in fluid connection with the plurality of air ports thereof and an air inlet in fluid connection with the one or more channels thereof which is configured to be placed in fluid connection with the source of pressurized air. The base of each of the plurality of seat cells may include one or more channels in fluid connection with the plurality of air ports thereof and an air inlet in fluid connection with the one or more channels thereof which is configured to be placed in fluid connection with the source of pressurized air.

In a number of embodiments, the pressure relief system further includes a control system configured to control air flow from the source of pressurized air to each of the plurality of backrest cells and to each of the plurality of seat sells. The control system may, for example, be configured to independently control air flow from the source of pressurized air to each of the plurality of backrest cells and to each of the plurality of seat sells. As described above, the control system may, in a number of embodiments, be configured to independently control air flow from the source of pressurized air to each of the plurality of backrest cells and to independently control air flow from the source of pressurized air to each of the plurality of seat sells. In a number of embodiments, the control system is configured to control air flow to the plurality of air ports of each of the plurality of backrest cells as a function of orientation of the plurality of backrest cells with respect to the gravity vector and control air flow to the plurality of air ports of each of the plurality of seat cells as a function of orientation of the plurality of seat cells with respect to the gravity vector. Groups of air ports and/or individual air ports may be controlled independently to effect and/or optimize fluidization of the resilient elements over a range of angles backrest cells and/or seat cells with respect to the gravity vector.

The present devices, systems, methods and compositions], along with the attributes and attendant advantages thereof, will best be appreciated and understood in view of the following detailed description taken in conjunction with the accompanying drawings.

### BRIEF DESCRIPTION OF THE DRAWINGS

FIG. 1. illustrates a side view of an example of a powered wheel chair in connection with which the devices, systems, and methods hereof may be used.

FIG. 2A illustrates a side view of a system hereof including a backrest support or cushion and a seat support or cushion which may be used in connection with a manual wheelchair, a powered wheelchair, or another seating system.

FIG. 2B illustrates a top view of the system of FIG. 2A.

FIG. 2C illustrates schematically a transparent view of one of the cells of the system of FIG. 2A wherein resilient elements or members (for example, elastomeric, closed-cell foam beads or balls) within the cell are fluidized by pressurized air.

FIG. 3 illustrates a perspective view of the system of FIG. 2A, including a source of pressurized air (for example, a compressor, a micro-compressor, or a turbine) in fluid connection with each cell independently via a manifold and a control system in operative connection with the source of pressurized air and manifold.

FIG. 4A illustrates a photograph of an embodiment of the collapsible cell material or fabric of a cell hereof removed from a base, wherein the inner surface of the cell material is turned outward or inside out.

FIG. 4B illustrates a photograph an embodiment of a cell hereof, which is formed from the material of FIG. 4A, in a fluidized state.

FIG. 4C illustrates a photograph of the cell of FIG. 4B in a fluidized state supporting a weight.

FIG. 5A illustrates a bottom isometric and hidden line view of an embodiment of a cell of a support system hereof with the fluidizable elements removed therefrom.

FIG. 5B illustrates a top isometric and hidden line view of the cell of Figure SA hereof with the fluidizable elements removed therefrom.

FIG. 5C illustrates another top isometric and partially hidden line view of the cell of FIG. 5A hereof with the fluidizable elements removed therefrom.

FIG. 5D illustrates a top isometric and hidden line view of an embodiment of a base of a cell hereof.

FIG. 5E illustrates an isometric and partially hidden line view of a cell including the base of FIG. 5D.

FIG. 5F illustrates an isometric view of the cell of FIG. 5E.

FIG. 5G illustrates an isometric and partially hidden line view of the cell of FIG. 5E with fluidized elements therein (illustrated as spheres in dashed lines).

FIG. 5H illustrates a perspective view of another embodiment of a base of a cell hereof.

FIG. 6A illustrates a photograph of an experimental setup for study of fluidization of elements including a transparent cylinder attached to a cell base hereof, wherein there is no air flow.

FIG. 6B illustrates the experimental setup of FIG. 6A wherein the elements are partially fluidized via air flow through the base.

FIG. 7A illustrates an embodiment of a Material Testing System (MTS 58 Bionix II) used to study the response of a cell hereof under various operating conditions.

FIG. 7B illustrates a force displacement curve of a cell hereof determined using the system of FIG. 7A.

FIG. 8A illustrates a photograph of a seat support or cushion system hereof which includes seat cells hereof placed in operative connection with a powered wheelchair system.

FIG. 8B illustrates a photograph of a user seated upon the seat support or cushion system of FIG. 8A.

### DETAILED DESCRIPTION

It will be readily understood that the components of the embodiments, as generally described and illustrated in the figures herein, may be arranged and designed in a wide variety of different configurations in addition to the described representative embodiments. Thus, the following more detailed description of the representative embodiments, as illustrated in the figures, is not intended to limit the scope of the embodiments, as claimed, but is merely illustrative of representative embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein and in the appended claims, the singular forms “a,” “an”, and “the” include plural references unless the context clearly dictates otherwise. Thus, for example, reference to “a cell” includes a plurality of such cells and equivalents thereof known to those skilled in the art, and so forth, and reference to “the cell” is a reference to one or more such cells and equivalents thereof known to those skilled in the art, and so forth. Recitation of ranges of values herein are merely intended to serve as a shorthand method of referring individually to each separate value falling within the range. Unless otherwise indicated herein, and each separate value, as well as intermediate ranges, are incorporated into the specification as if individually recited herein. All methods described herein can be performed in any suitable order unless otherwise indicated herein or otherwise clearly contraindicated by the text.

In a number of embodiments, systems and devices hereof prevent and/or facilitate healing of pressure injuries, especially during treatment after flap surgery. The system and devices hereof may, for example, operate as a bridge during recovery from a pressure injury.

As set forth above, there are no Group 3 support surfaces available as wheelchair cushions or backrests to support an individual once they transition to sitting in a wheelchair. Pressure injuries are likely to reoccur after, for example, a flap surgery. Location of such injuries on the ischial tuberosities indicates that transition from lying to sitting upright in a wheelchair is likely a risk factor for inadequate healing of flap tissue and further indicates that current strategies to offload pressure in the wheelchair are not as effective as air-fluidized therapy in bed. The devices, systems, and methods hereof address this critical gap by providing the first air-fluidized wheelchair cushion and/or backrest. The devices, systems, and methods hereof provide the added benefit of enabling a sitting position and mobility in a wheelchair while diminishing the risks associated with pressure injuries. Compared to air-fluidized beds, the modular cells hereof are significantly smaller, are lighter in weight, use significantly lower power, and are portable. Moreover, separate seat and backrest supports, cushions or cushion systems including a plurality of modular cells hereof may be provided. Air flow/fluidization in each modular cell hereof may be controlled to provide efficient fluidization and/or pressure relief through, for example, differentials in pressurization over the area of a cushion system, controlling areas of cell cover through which air may pass, etc.

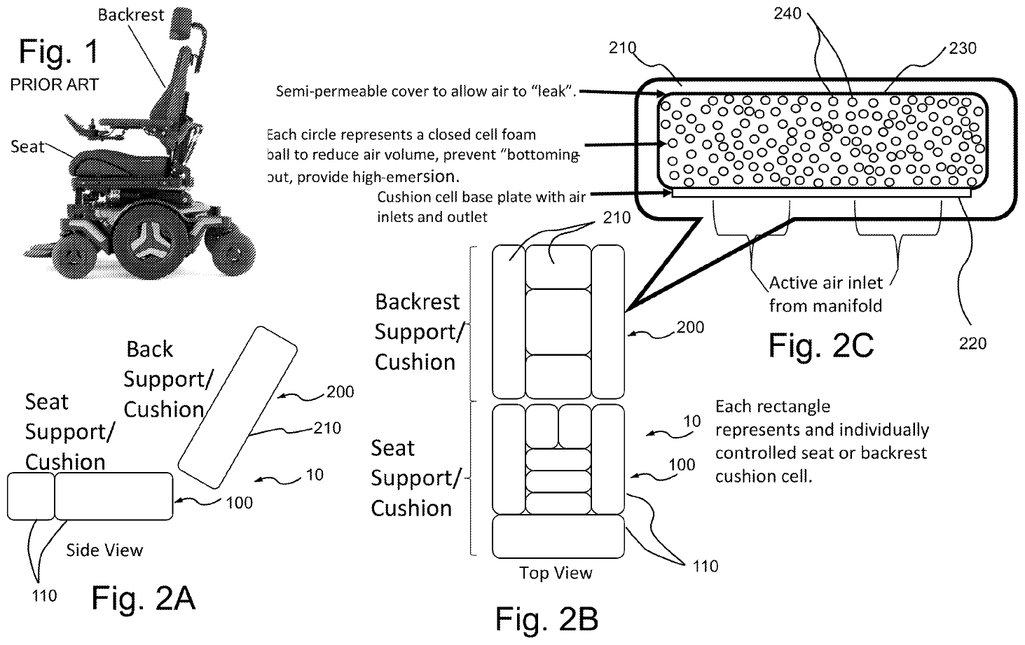

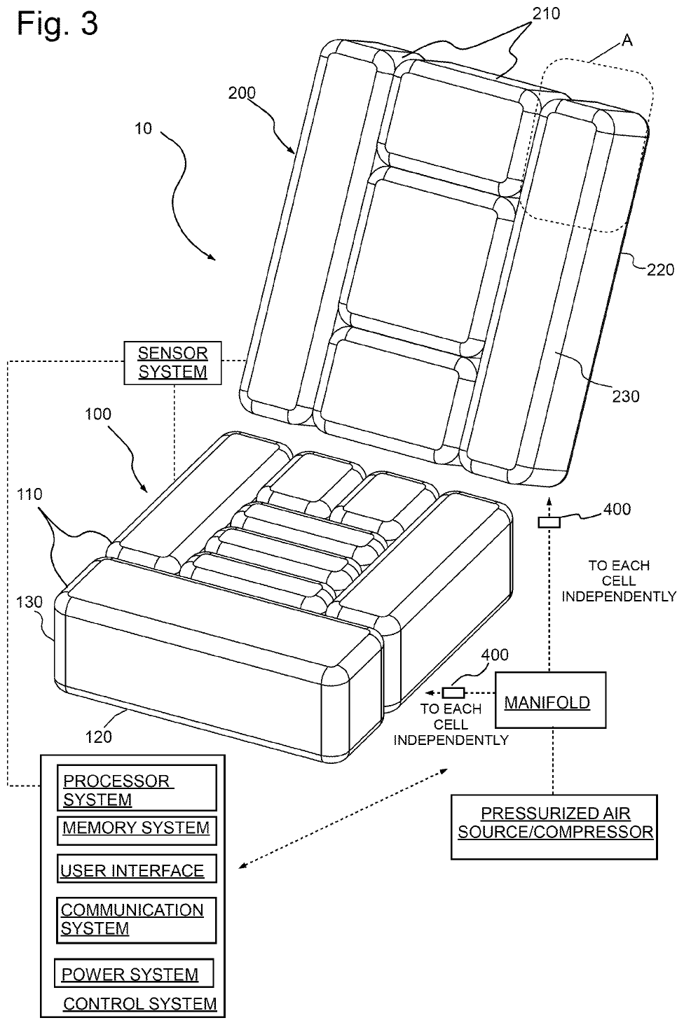

Computer aided-design (CAD) solid-models were used in developing and fabricating a number of embodiments devices, systems, and methods hereof for use with, for example, manual or powered wheelchairs (see FIG. 1 for an example of a powered wheelchair). As illustrated in FIGS. 2A through 3, an embodiment of a system 10 hereof includes a seat support or cushion 100 and a back/backrest support or cushion 200. Each of seat support 100 and backrest support 200 includes individual, modular cells 110 and 210 respectively. In general, individual cells 110 and cells 210 may differ in, for example, number, position, and/or dimensions for a particularly use and/or user, but are constructed in the same manner. Elements of cells 210 are numbered similarly to like element of cells 210. Not all element of cells 210 are illustrated in the drawings. However, such elements are generally the same or similar to like element of cell 110.

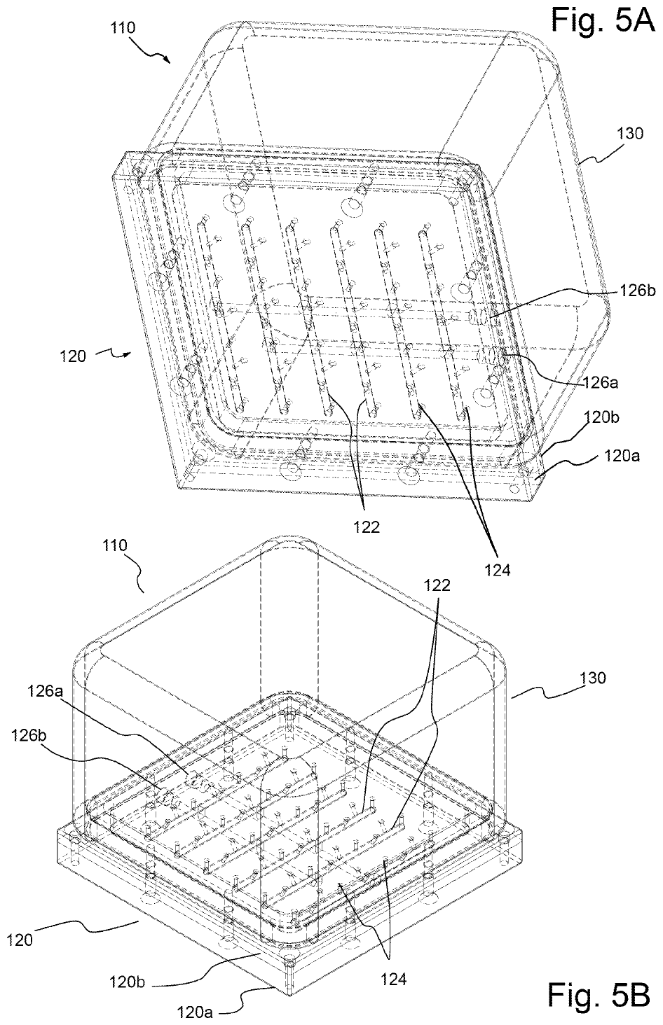

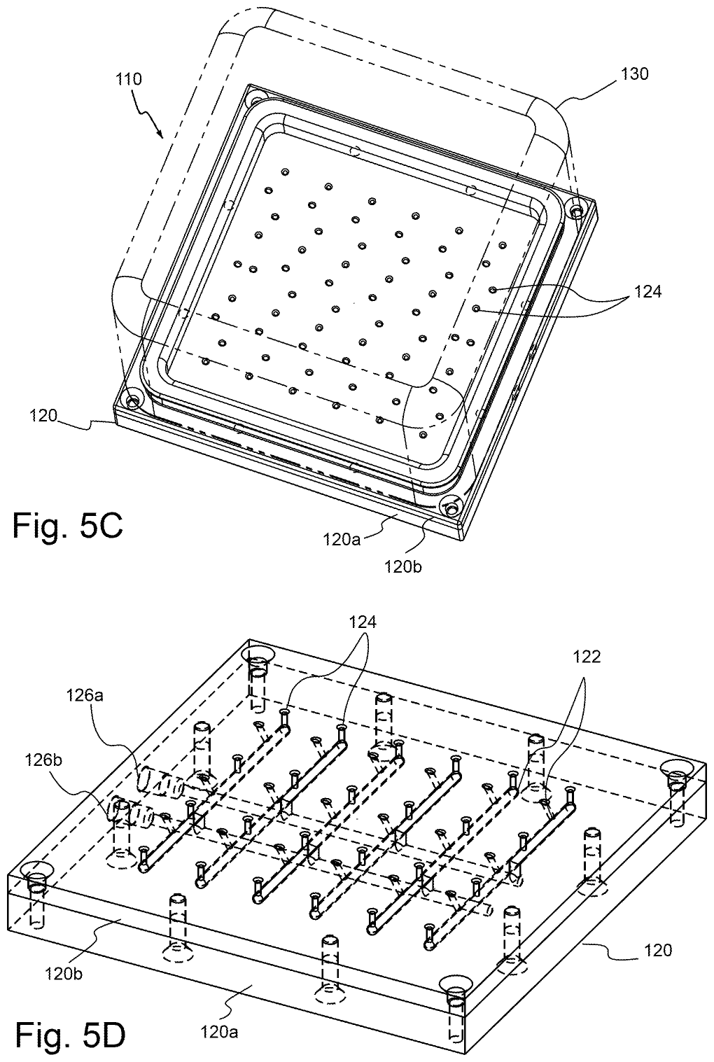

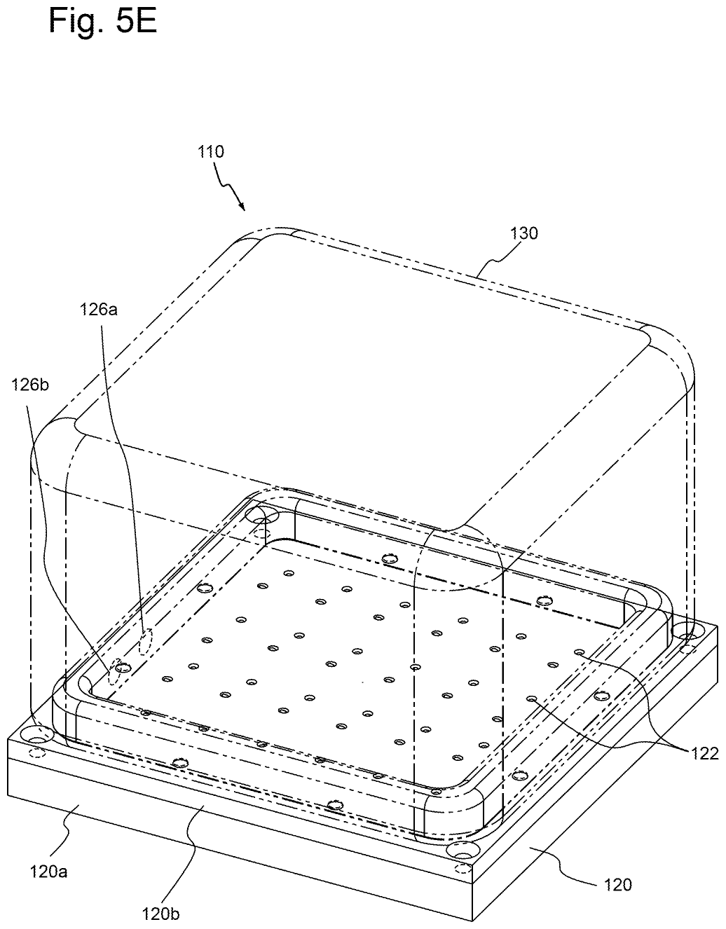

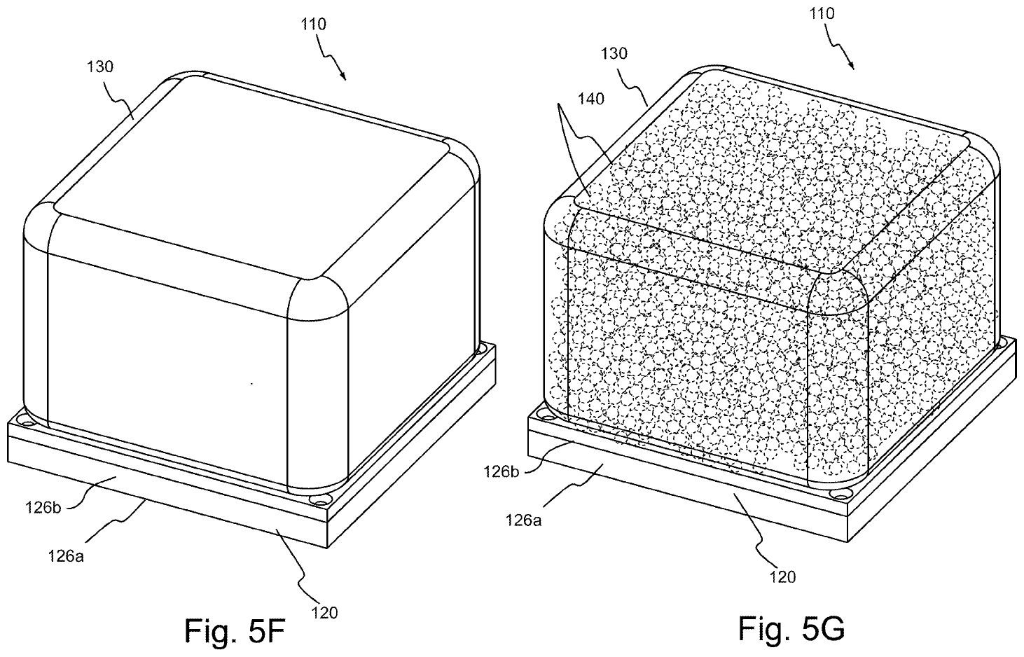

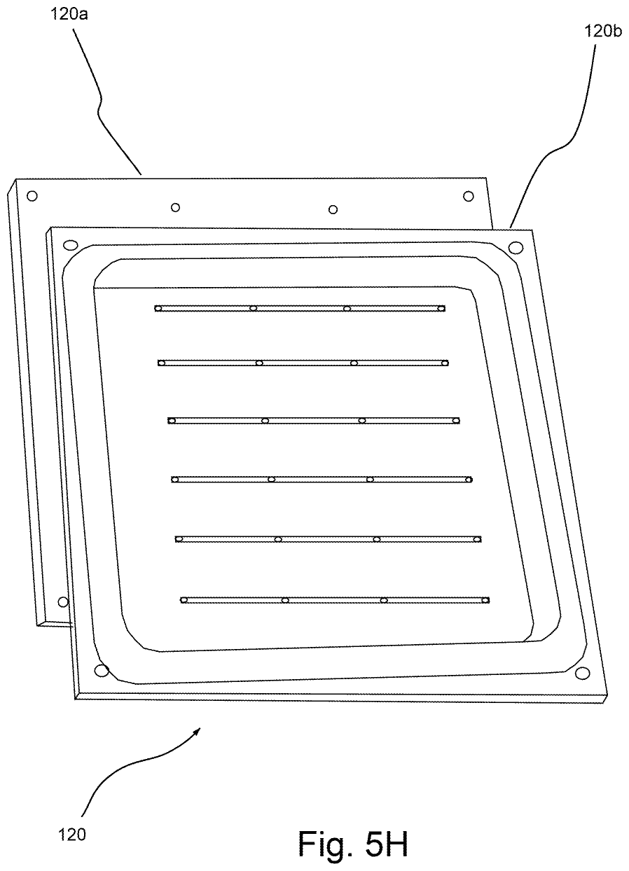

As, for example, illustrated in FIGS. 2C and 5A, each cell 210 (as well as each cell 110) includes a base 220 and a cover 230 connected to base 220 in which elements such as resilient elements 240 (for example, beads or balls) are fluidized. In a number of embodiments, at least a portion of cover 230 is permeable/semipermeable such that air can pass therethrough. Each cell 110 and 210 in system 10 may, for example, be controlled for pressure and flow though, for example, solid-state pressure transducers 400 (represented schematically in FIG. 3) and a manifold in operative connection with a source of pressurized air (for example, a compressor, a micro-compressor, or a turbine/blower/fan) to control inlet-outlet air. System 10 may, for example, be built with a modular design with components that can be exchanged without the need to replace the entire system. The modular design of system 10 allows clinicians to, for example, order or design a system 10 with different cell configuration (including, for example, number, size, arrangement, etc.) to, for example, accommodate a client's body size and body type, as well as to accommodate individual pressure tolerance, wounds, scars, deformities, etc.

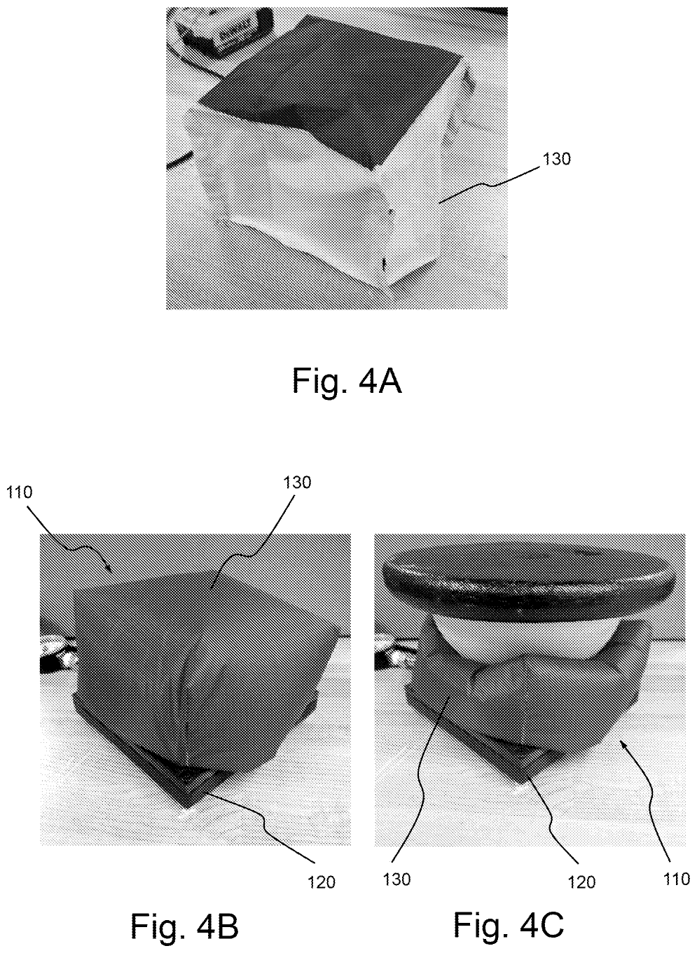

In a number of studied, representative embodiments, cell covers 130 and 230 were fabricated from microfiber ripstop nylon (MRN). The internal surface of covers 130 and 230 were coated with a hypoallergenic sealant to reduce air loss except through the top surface. FIG. 4A illustrates cover 130 turned inside out and showing the treatment of the side surfaces thereof with the sealant, while the upper, darker-colored surface is untreated. Allowing air to flow through the untreated upper or top surface of covers 130 and 230 may, for example, assist in cooling and wicking away moisture, while managing total air volume and flow within cells 110 and 210. MRN was chosen for certain embodiments because is durable, affordable, and provides a low-friction surface. Materials which are not naturally pervious or permeable to air may be used herein and micropores or micro-perforations may be formed in determined areas of covers formed from such materials to provide airflow therethrough in a manner to, for example, control airflow within the cells,

In a number of studied, representative embodiments, bases 120 and 220 were fabricated from a medical grade nylon using a selective-laser-sintering 3D printer (see, for example, FIGS. 4B through 5H). Using bases 120 as representative examples (bases 220 were essentially identically each manufactured), base 120 was made from two components/sections 120a/120b containing airflow channels 122 and the air ports or stream jets 124. Base sections 120a and 120b were attached (for example, bolted) together with a rubber/elastomeric seal or other seal between them. In production, such components may, for example, be machined or injection molded to facilitate production. Although tubing may be used, incorporating airflow channels 122 into sections 120a and 120b of base 120 eliminates the need for tubing, and air ports or jets 124 may be formed (for example, drilled) into base 120 at determined positions (which are readily determinable using engineering principles and/or routine experimentation) to control airflow in a manner to fluidize resilient or elastomeric elements 140 and to help ensure their relatively even distribution within cell 110, even as the seat or the back-support angles of the wheelchair change. In a number of studied embodiments, each cell was filled to about 60% by volume with resilient or elastomeric elements 140/240. In general, a number of resilient materials suitable for use herein have the ability to absorb energy when deformed elastically and release that energy upon unloading. Fluidized elements 140/240 assists in providing damping and stability, which are common problems with active air cushions, Elements 140/240 also provide a failsafe mechanism should an air cell 110/210 leak or in the case of other system malfunction. In that regard, even absent air flow, resilient elements will provide cushioning for the user. Elements 140/240 may also provide some light mechanical stimulation when fluidized. Air is introducing into base 120 via an air inlet 126a in fluid connection with air channels 122. An air outlet 126b may also be provided in fluid connection with air channels 122. In a number of studies hereof, air outlet 126b was blocked, and all air introduced via air inlet 126a exited cells 110/210 through cover 130/230 via its upper surface as discussed above. Blowing air through channels 122 in base 120 and into the air cell 110 via air stream ports/jets 124 at a determined angle, pressure, and rate of flow can achieve optimum fluidization.

Each cell 110/210 may, for example, include 30 to 90% by volume of resilient elements 140/240. In a number of embodiments, resilient elements are generally spherical (for example, wherein the effective diameter does not vary by more than 10% from an average diameter) or spherical in shape. In a number of embodiments, the average diameter of the resilient elements is greater than 1 mm, or greater than 2 mm. In a number of embodiments, the average diameter is between 1 and 12 mm. In a number of embodiments, resilient elements 140/240 are formed from a polymeric material (for example, a polyurethane, a neoprene, a nitrile rubber, a silicone, etc.) Resilient element 140/240 may, for example, be formed from a hypoallergenic material. In general, the size, shape, volume, and/or resiliency of resilient elements 140/240 are readily determined for a given application using engineering principles and/or routine experimentation.

In the illustrated embodiments, air ports/jets 124 are illustrated as extending generally orthogonal to the orientation of a generally flat surface of base 120. Portions of the surface of base 120 may be angled or curved, and/or air ports/jets 124 may extend therefrom at an angle other than an orthogonal angle to achieve predetermined initial vector of air from such air ports and predetermined air flow patterns within cells 110 (or cells 210). Moreover, a plurality of air inlets or a manifold system may be provided in base 120 in operative connection with air ports/jets 124 to effect differential control of air flow to the various air ports/jets 124 thereof. In that regard, groups of air ports and/or individual air ports may be controlled individually in, for example, response to a determined change in orientation of a cell 110 with respect to the gravity vector. For example, flow rate in air ports positioned lower with respect to the orientation gravity vector can be increased compared to other air ports. Further, air-port diameter (that is, orifice/opening size) may be selected (which may vary by location) to provide desirable air flow patterns to achieve desired inflation/fluidization.

The angle of a wheelchair backrest may, for example, range between approximately 90° and 135° with respect to horizontal (wherein 90° is aligned with the gravity vector). In addition or in the alternative, a soft, resilient material such as a foam may be used in airflow “dead zones” of, for example, backrest cells 210 or in areas of cells 210 in which resilient elements 240 tend to settle. Such “filler” materials may also be used to assist in controlling airflow within cells hereof. Moreover, the area through which air may pass in covers 230 (as well as covers 130) may be controlled to facilitate fluidization of resilient elements 240. For example, an upper (with respect to the gravity vector) area of cover 230 (as, for example, encompassed by dashed area A in FIG. 3) may be formed such that air may pass therethrough (as described above) while the remainder of cover 230 is impervious to air under the flow rates and pressure used in connection with cell 210.

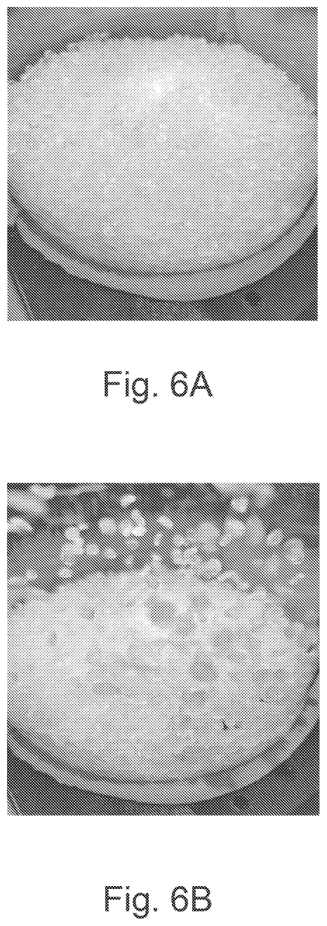

Element (for example, beads or balls) fluidization tests were conducted using a base similar in function to base 110 in operative connection with a clear acrylic plastic cylinder as illustrated in FIGS. 6A and 6B to visually determine if, when air flowed through air stream jets/ports 124 of base 110, elements 140 begin to separate and rise. Fluidization was readily achieved as illustrated in FIG. 6B. Visually, elements 140 began to separate and act like fluid or particles suspended in a fluid, and with increasing flow the beads began to “popcorn” as was anticipated.

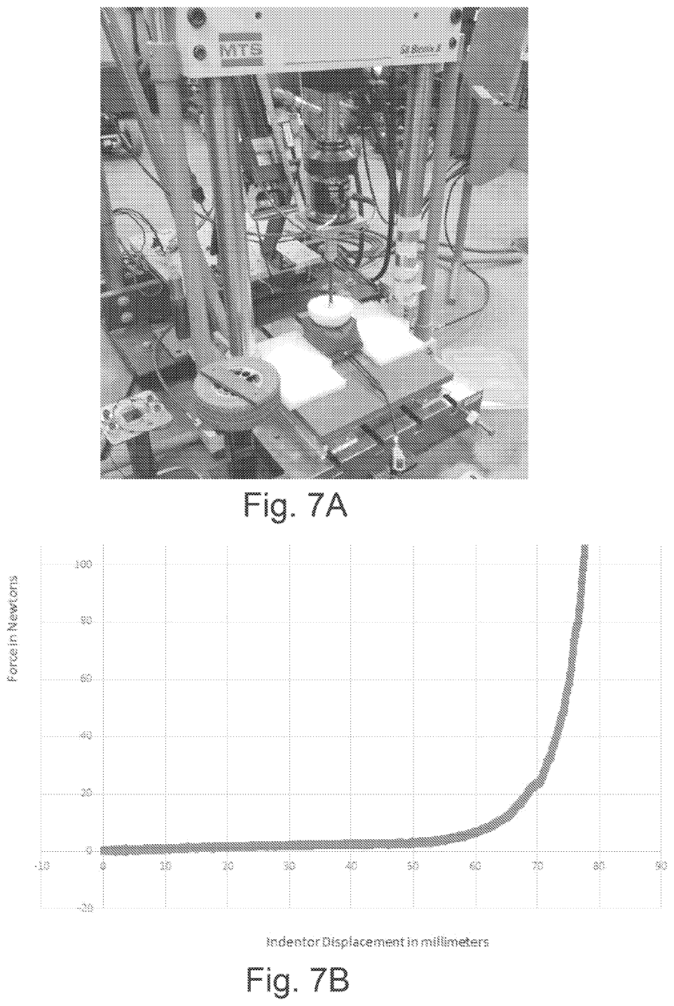

After successfully indicating the achievement of fluidization, single cells 110 were fabricated as described above (see, for example, FIGS. 4A through 4C). Cell 110 was assembled from components as described above and loaded with a spherical section representing one ischial tuberosity region and then loaded with 10 pounds and 15 pounds (see, FIG. 4C) to determine floatation and immersions while maintaining fluidization of elements/beads 140. Fluidization was verified by touching the side of the MRN cover. After conducting those simple verification tests, additional cells 110 were created using the same design and tested in a Material Testing System (MTS) as illustrated in FIG. 7A. The MTS experiment examined force-displacement curves to demonstrate that flow rates and pressures, adequate immersion, and interface pressure could be achieved with a reasonable sized micro-compressor or turbine.

As used herein, “immersion” refers to how deep the buttocks or back sink below the seat cushion or backrest cushion, respectively. Immersion is adequate when the body floats and is de-weighted (that is, does not sink such that it contacts the surface below the seat cushion or backrest cushion). Interface pressure is the distribution of forces acting at the interface between the seat cushion or backrest cushion and the body. Conventionally, manufacturers of pressure-relief products indicate that any load that exceeds 32 mmHg (4266 Pa) is harmful. This value came from an early study that calculated the capillary pressure of the fingernail bed to be approximately 32 mmHg (4266 Pa) and also from microscopic studies in which 32 (4266 Pa) to 40 mmHg (5333 Pa) was considered a safe threshold. However, there is no cutoff value for load that is known to be causative for ulcer formation. Generally, clinicians measure both peak and average interface pressure and correlate the distribution of pressures with areas of the body that may be prone to skin breakdown. This characterization allows them to determine whether the interface pressure is adequate for the user's need. Pressures and flow rates for particular embodiments hereof may be optimized for such embodiments using engineering principles known in the art and routine experimentation.

In a number of representative embodiments, pressure is maintained relatively low in the modular cells of the supports or cushions hereof. For example, pressure may be maintained below 5 psi (34.5 kPa), below 4 psi (27.6 kPa), or below 3 psi (20.7 kPa). Flow rate (cumulative for all air ports or jets) in such embodiments may, for example, be in the range of 14 cubic feet/second (cfm; 0.0066 cubic meter/second) to 30 cfm (0.0142 cubic meter/second). In such embodiments, a turbine, blower or fan system may be used which is designed for relatively high flow rates at relatively low pressure. Such systems are readily available at low cost, and are fan-/vane-based systems rather than positive displacement systems. Turbines used in CPAP devices and cooling fans for bit-coin mining may, for example, be used herein. Examples of suitable turbines/blowers and fans include, but are not limited to, the RV45-3/14S fan blower available, for example, from Digi-Key Electronics of Thief River Falls, MN USA under part number 381-RV45-3/14S-ND and the FFB0412HHN fan available, for example, from Digi-Key Electronics under part number 603-1411-ND.

A representative force displacement curve is presented in FIG. 7B, showing that for the emersion depths specified in ISO 16840-2:2018 (Wheelchair Seating), the disclosure of which is incorporate herein by reference, cells 110/210 achieve the desired pressure (force×surface area) and there is a rise in the force as the displacement increase and the beads start to compress and are no longer suspended (that is, fluidized). As expected, there is a knee in the force-displacement curve when the beads start to compress and support some of the load. The results indicate that system 10 as whole will provide temporary support and relief in a “run flat” scenario, which is not available with other air suspension seating systems.

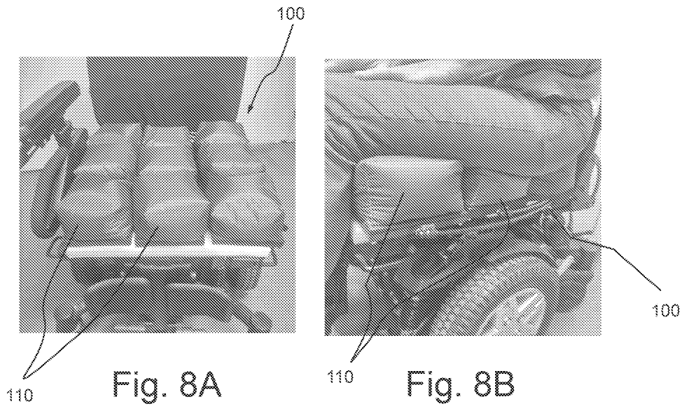

As illustrated in FIGS. 8A and 8B, an embodiment of a seat support or cushion 100 including nine cells 110 was fabricated. An experienced therapist, who is an expert in wheelchair seating (that is, a physical therapist (PT) and assistive technology professional (ATP) with greater 20 years' experience and who has also fitted over 1,000 people for wheelchairs), used seat support 100 and provided comments. The initial feedback was positive, with the therapist reporting that seat support 100 was comfortable, that the airflow through covers 130 and its cooling effects were felt, and that seat support 100 was stable.

Studies of systems 10 hereof may readily be undertaken to further develop, optimize, and evaluate systems 10 hereof for improving pressure injury outcomes for individual patients in, for example, in-home treatment. The size, shape, and number of “cells”; the material properties (user weight capacity, friction minimization, permeability, cover-cell interaction); air flow and pressure; bead/ball volume and type; and power consumption and source (i.e., minimal or no impact on EPW range) may, for example, be readily optimized for particular uses. Systems 10 hereof may readily be integrated with power seat functions of wheelchairs to optimize pressure relief. The use of power seat functions to alleviate pressure is, for example, discussed in U.S., Patent Application Publication Nos. 2015/0209207 2021/0267826, the disclosures of which are incorporated herein by reference. Multiple prototypes may, for example, be iteratively designed and built for evaluation.

As, for example, illustrated in FIG. 3, electronic circuitry, including a software-based control system, may be provided to control the operation of system 10 as well as the interaction with power seat functions of a wheelchair. Such software (which is stored in a memory system and is executable by a processor system) may, for example, include a user interface, control of air pressure and flow of each cell of the supports, coordination and control of power seat functions along the support surfaces, and a coaching function. For example, seat tilt and/or backrest recline can change the orientation of cells 110/210 with respect to the gravity vector and may require a change in control of air flow to cells 110/210 to maintain a desired fluidization profile. Various sensor such as tilt sensors, inclinometers, accelerometers, temperature sensors, etc. may be provided in a sensor system as illustrated in FIG. 3 to, for example, determine the angle of a cell 110/210 with respect to the gravity vector, environmental conditions, etc. that may, for example, affect control of air flow for fluidization.

Air flow to cells 110 and/or 210 may be individually controlled via the control system to, for example, achieve active control of air flow, pressure, and/or fluidization within individual cells 110 and/or 210 to achieve a treatment/prevention protocol. For example, rippling and/or other effects across the surface of seat support 100 and/or back support 200 may be achieved.

The terms “electronic circuitry”, “circuitry” or “circuit,” as used herein include, but is not limited to, hardware, firmware, software, or combinations of each to perform a function(s) or an action(s). For example, based on a desired feature or need. a circuit may include a software-controlled microprocessor, discrete logic such as an application specific integrated circuit (ASIC), or other programmed logic device. A circuit may also be fully embodied as software. As used herein, “circuit” is considered synonymous with “logic.” The term “logic”, as used herein includes, but is not limited to, hardware, firmware, software, or combinations of each to perform a function(s) or an action(s), or to cause a function or action from another component. For example, based on a desired application or need, logic may include a software-controlled microprocessor, discrete logic such as an application specific integrated circuit (ASIC), or other programmed logic device. Logic may also be fully embodied as software.

The term “processor,” as used herein includes, but is not limited to, one or more of virtually any number of processor systems or stand-alone processors, such as microprocessors, microcontrollers, central processing units (CPUs), and digital signal processors (DSPs), in any combination. The processor may be associated with various other circuits that support operation of the processor, such as random-access memory (RAM), read-only memory (ROM), programmable read-only memory (PROM), erasable programmable read only memory (EPROM), clocks, decoders, memory controllers, or interrupt controllers, etc. These support circuits may be internal or external to the processor or its associated electronic packaging. The support circuits are in operative communication with the processor. The support circuits are not necessarily shown separate from the processor in block diagrams or other drawings.

The term “controller,” as used herein includes, but is not limited to, any circuit or device that coordinates and controls the operation of one or more input and/or output devices. A controller may, for example, include a device having one or more processors, microprocessors, or central processing units capable of being programmed to perform functions.

The term “logic,” as used herein includes, but is not limited to. hardware, firmware, software, or combinations thereof to perform a function(s) or an action(s), or to cause a function or action from another element or component. Based on a certain application or need, logic may, for example, include a software controlled microprocess, discrete logic such as an application specific integrated circuit (ASIC), or other programmed logic device. Logic may also be fully embodied as software. As used herein, the term “logic” is considered synonymous with the term “circuit.”

The term “software,” as used herein includes, but is not limited to, one or more computer readable or executable instructions that cause a computer or other electronic device to perform functions, actions, or behave in a desired manner. The instructions may be embodied in various forms such as routines, algorithms, modules, or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, or the desires of a designer/programmer or the like.

Various aspect of the control system hereof may, for example, be incorporated in a personal communication device. As used herein, the term “personal communications device” refers to a portable or mobile device which includes a communication system, a processor system, a user interface system (for example, a visual feedback system including a touchscreen or other display, an auditory feedback system, and a tactile feedback system, a user input system etc.) and an operating system capable of running general-purpose applications. Examples of personal communications devices include, but are not limited to, smartphones, tablet computer and custom devices. As used herein, the term “tablet computer” or tablet, refers to a mobile computer with a communication system, a processor system, at least one user interface as described above (typically including a touchscreen display), and an operating system capable of running general-purpose applications in a single unit. As used herein, the term “smartphone” refers to a cellular telephone including a processor system, at least one user interface as described above (typically including a touchscreen display), and an operating system capable of running general-purpose applications. Such personal communication devices are typically powered by rechargeable batteries and are housed as a single, mobile unit. Moreover, in a number of embodiments personal communications devices are able accept input directly into a touchscreen (as opposed to requiring a keyboard and/or a mouse). Personal communications devices as typically provide for internet access through cellular networks and/or wireless internet access points connected to routers. A number of representative embodiments of systems and/or methods hereof are discussed in connection with the user of a smartphone as the personal communication device.

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

1. A pressure relief system for use with a wheelchair, comprising:
a backrest support comprising a plurality of backrest cells, each of the plurality of backrest cells comprising a base which comprises a plurality of air ports, a cover in connection with the base, and resilient elements within an interior of each of the plurality of backrest cells,
a seat support comprising a plurality of seat cells, each of the plurality of seat cells comprising a base which comprises a plurality of air ports, a cover in connection with the base, and resilient elements within an interior of each of the plurality of seat cells, and
a source of pressurized air in fluid connection with the plurality of air ports of each of the plurality of backrest cells and with the plurality of air ports of each of the plurality of seat cells via which the resilient elements within each of the plurality of backrest cells and the resilient elements within each of the plurality of seat cells are fluidizable.

2. The pressure relief system of claim 1 wherein at least a portion of each cover of the plurality of backrest cells is permeable to air and at least a portion of each cover of the plurality of seat cells is permeable to air.

3. The pressure relief system of claim 2 wherein each of the plurality of backrest cells comprises between 30% and 90% by volume of the resilient elements and wherein each of the plurality of seat cells comprises between 30% and 90% by volume of the resilient elements.

4. (canceled)

5. The pressure relief system of claim 3 wherein the resilient element have an average diameter greater than 2 mm.

6. (canceled)

7. The pressure relief system of claim 2 wherein the base of each of the plurality of backrest cells comprises one or more channels in fluid connection with the plurality of air ports thereof and an air inlet in fluid connection with the one or more channels thereof which is configured to be placed in fluid connection with the source of pressurized air, and the base of each of the plurality of seat cells comprises one or more channels in fluid connection with the plurality of air ports thereof and an air inlet in fluid connection with the one or more channels thereof which is configured to be placed in fluid connection with the source of pressurized air.

8. The pressure relief system of claim 2 further comprising a control system configured to control air flow from the source of pressurized air to each of the plurality of backrest cells and to each of the plurality of seat sells.

9. The pressure relief system of claim 8 wherein the control system is configured to independently control air flow from the source of pressurized air to each of the plurality of backrest cells and to independently control air flow from the source of pressurized air to each of the plurality of seat sells.

10. The pressure relief system of claim 8 wherein the control system is configured to control air flow to the plurality of air ports of each of the plurality of backrest cells as a function of orientation of the plurality of backrest cells with respect to the gravity vector and control air flow to the plurality of air ports of each of the plurality of seat cells as a function of orientation of the plurality of seat cells with respect to the gravity vector.

11. A method of providing pressure support in a wheelchair, comprising:
providing a backrest support comprising a plurality of backrest cells, each of the plurality of backrest cells comprising a base which comprises a plurality of air ports, a cover in connection with the base, and resilient elements within an interior of each the plurality of backrest cells, a seat support comprising a plurality of seat cells, each of the plurality of seat cell comprising a base which comprises a plurality of air ports, a cover in connection with the base, and resilient elements within an interior of each of the plurality of seat cells, and a source of pressurized air in fluid connection with the plurality of air ports of each of the plurality of backrest cells and in fluid connection with each of the plurality of ports of each of the plurality of seat cells, and
passing pressurized air through the plurality of air ports of the base of each plurality of backrest cells and through the plurality of air ports of the base of each the plurality of seat support cells via the source of pressurized air to fluidize the resilient elements within each of the plurality of backrest cells and within each of the plurality of seat cells.

12. The method of claim 11 wherein at least a portion of each cover of the plurality of backrest cells is permeable to air and at least a portion of each cover of the plurality of seat cells is permeable to air.

13.-17. (canceled)

18. The method of claim 12 further comprising providing a control system in operative connection with the seat support and with the backrest support which is configured to control air flow from the source of pressurized air to each of the plurality of backrest cells and to each of the plurality of seat sells.

19. The method of claim 18 wherein the control system is configured to independently control air flow from the source of pressurized air to each of the plurality of backrest cells and to independently control air flow from the source of pressurized air to each of the plurality of seat sells.

20. The method of claim 18 wherein the control system is configured to control air flow to the plurality of air ports of each of the plurality of backrest cells as a function of orientation of the plurality of backrest cells with respect to the gravity vector and control air flow to the plurality of air ports of each of the plurality of seat cells as a function of orientation of the plurality of seat cells with respect to the gravity vector.

21. The method of claim 12 further comprising selecting the number, size and configuration of each of the plurality of backrest cells and each of the plurality of seat cells on the basis of at least one predetermined criterion.

22. A pressure relief system for use with a seating system in which a user can sit upright, comprising:
a seat support comprising a plurality of seat cells, each seat cell comprising a base which comprises a plurality of air ports, a cover in connection with the base, and a plurality of resilient elements within an interior of each seat cell, and
a source of pressurized air in fluid connection with the plurality of air ports of the plurality of seat cells via which the resilient elements within each of the plurality of seat cells are fluidizable.

23. The pressure relief system of claim 22 further comprising a backrest support comprising a plurality of backrest cells, each backrest cell comprising a base which comprises a plurality of air ports, a cover in connection with the base, and a plurality of resilient elements within an interior of each of the plurality of backrest cells, the source of pressurized air being in fluid connection with the plurality of ports of each of the plurality of backrest cells via which the resilient elements within each of the plurality of backrest cells are fluidizable.

24. The pressure relief system of claim 23 wherein at least a portion of each cover of the plurality of backrest cells is permeable to air and at least a portion of each cover of the plurality of seat cells is permeable to air.

25. The pressure relief system of claim 24 wherein each of the plurality of backrest cells comprises between 30% and 90% by volume of the resilient elements and wherein each of the plurality of seat cells comprises between 30% and 90% by volume of the resilient elements.

26.-29. (canceled)

30. The pressure relief system of claim 24 further comprising a control system configured to independently control air flow from the source of pressurized air to each of the plurality of backrest cells and to independently control air flow from the source of pressurized air to each of the plurality of seat sells.

31. (canceled)

32. The pressure relief system of claim 30 wherein the control system is configured to control air flow to the plurality of air ports of each of the plurality of backrest cells as a function of orientation of the plurality of backrest cells with respect to the gravity vector and control air flow to the plurality of air ports of each of the plurality of seat cells as a function of orientation of the plurality of seat cells with respect to the gravity vector.
